(19) United States
(12) Patent Application Publication
(10) Pub. No.: US 2022/0295994 A1
(43) Pub. Date: Sep. 22, 2022

(54) HUNTER'S HEAD REST

(71) Applicant: Michael P. Madden, Howell, MI (US)

(72) Inventor: Michael P. Madden, Howell, MI (US)

(21) Appl. No.: 17/696,273

(22) Filed: Mar. 16, 2022

Related U.S. Application Data
(60) Provisional application No. 63/161,630, filed on Mar. 16, 2021.

(51) Int. Cl. A47C 7/38

(52) U.S. Cl. CPC A47C 7/38

(57) ABSTRACT

A head rest for mounting to a support member, such as a tree. The head rest includes an anchor attachable to the support member and a head support secured to the anchor. The head support further includes lateral portions extending laterally from a central portion.

### CROSS-REFERENCE TO RELATED APPLICATION

This application is a non-provisional of U.S. application No. 63/161,630, filed Mar. 16, 2021, the entire contents of which is herein incorporated by reference.

### FIELD OF THE INVENTION

The present invention generally relates to a head rest for use during outdoor activities. More specifically, the invention relates to a head rest that may be used while hunting. Even more specifically, the invention relates to a head rest that may be used while hunting from a stand attached to a tree or a seat positioned adjacent to a tree or other rigid support.

### BACKGROUND

When hunting from a stand, a hunter is required to remain in a single location for an extended prior of time. While the time spent in the stand during a given occasion is completely determined by the particular hunter, it is not unheard of for hunters to remain in the stand for four or more hours, or for the entire day.

Hunting stands may be fixed or portable and come in numerous varieties, including ground blinds, tree stands and other types of seats. Fixed ground blinds may be constructed as small rigid enclosure allowing the hunter to be completely concealed inside the enclosure. Such fixed enclosures may also be elevated on legs. Tree stands may be permanently attached to a tree or may be portable, allowing for removal each day or at the end of the season. Other types of seats are placed close to the base of a tree or attached near the base of a tree.

Regardless of the type of hunting stand, when long durations in the stand are desired, a hunter's comfort in the stand may directly impact the length of time they are willing to remain in the stand and it may also allow the hunter to remain more motionless in the stand.

### SUMMARY

Disclosed herein is a head rest that may be used in connection with hunting and a hunting stand of the above and other varieties. While described in connection with hunting, the head rest may also be used in connection with other outdoor activities, such as bird watching and outdoor wildlife photography.

In one aspect of the present invention, a head rest for mounting to a support member, such as a tree, is provided. The head rest includes an anchor and a head support. The anchor is attachable to the support member and the head support is secured to the anchor. The head support also includes lateral portions extending laterally from a central portion.

In another aspect, the head support is removably mounted to the anchor.

In a further aspect, the anchor is externally threaded for engagement with the support member.

In an additional aspect, the end of the anchor is provided in the form of a point.

In yet another aspect, the head support is threadably engaged with the anchor.

In still a further aspect, the head support includes a cradle and a mounting member connected at one end to the cradle, an opposing end of the mounting member terminating at the anchor, the cradle generally extending laterally relative to the mounting member.

In an additional aspect, the cradle is generally arcuate along its length.

In another aspect, the cradle includes lateral end portions connected by a central portion.

In a further aspect, the mounting member extends from the central portion.

In an additional aspect, the mounting member extends from a generally convex side of the cradle.

In another aspect, the cradle has a generally convex side facing toward the anchor.

In a further aspect, the the cradle has a generally concave side facing away from the anchor.

In an additional aspect, the anchor is provided with external threads at a first end and is provided with internal threads at a second end that is opposite from the first end.

In another aspect, the head support is removably engaged with the anchor via the internal threads.

Further objects, features and advantages of this invention will become readily apparent to persons skilled in the art after review of the following description, including the claims, and with reference to the drawings that are appended to and form a part of this specification

### BRIEF DESCRIPTION OF THE FIGURES

FIG. 1 is a perspective view of a head rest embodying the principles of the present invention, showing the head support assembled with the anchor.

FIG. 2 is perspective view of the head rest of FIG. 1 showing the head support disassembled from the anchor.

FIG. 3 is a close-up perspective view of the bolt of the head support rest disassembled from the anchor.

FIG. 4 is a close-up perspective view of the anchor of the head rest.

FIG. 5 is a close-up perspective view of the anchor seen in FIG. 4 when mounted to a tree.

FIG. 6 is a front perspective view of the head rest mounted to a tree.

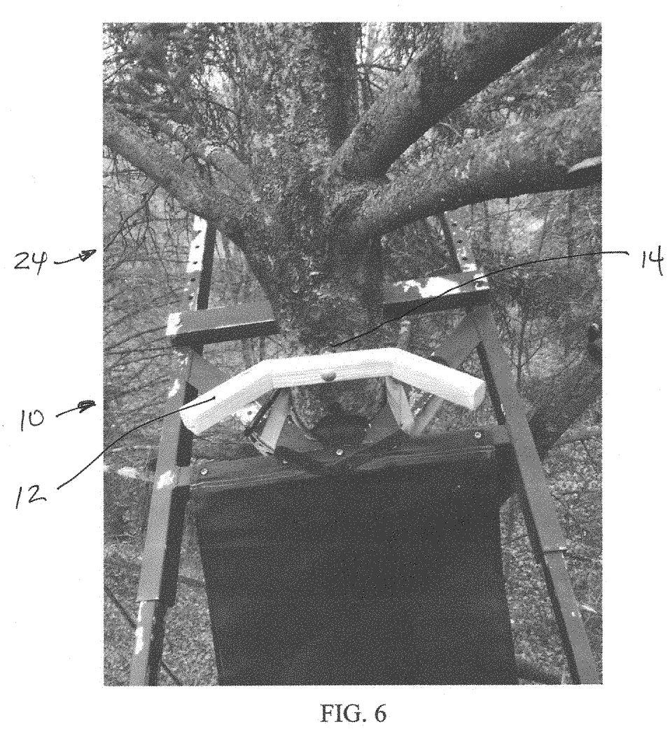

FIG. 7 is another perspective view of the head rest mounted to a tree.

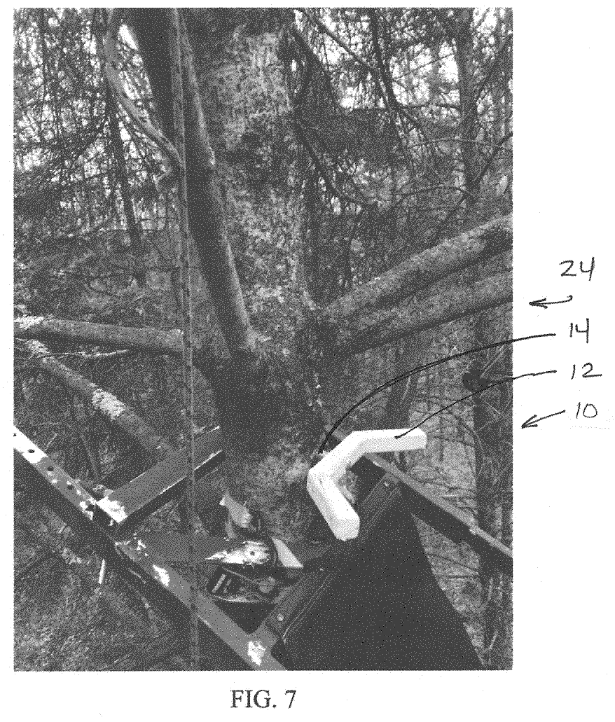

### DESCRIPTION

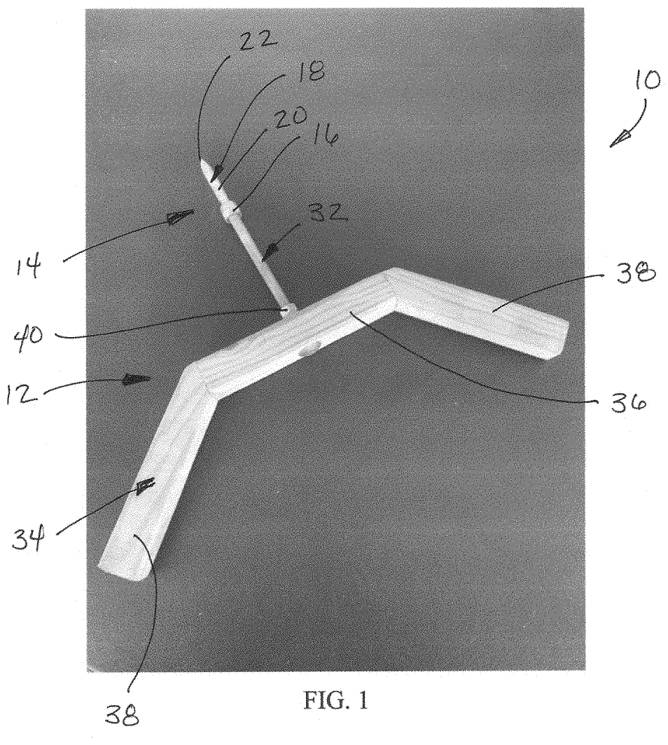

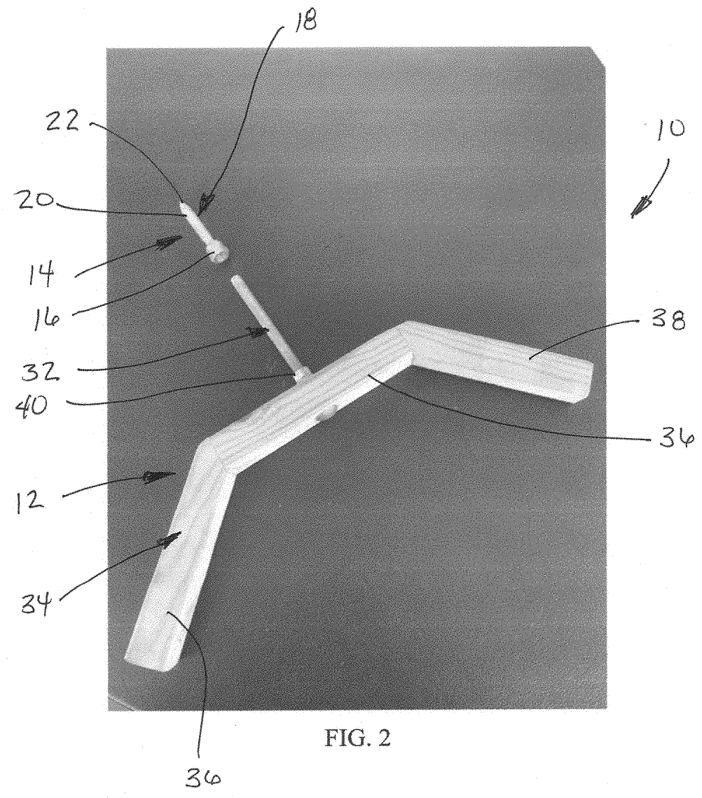

A head rest incorporating the principles of the present invention is shown in the figures. As its main components, the head rest 10 includes a head support 12 and an anchor 14. In a preferred embodiment, the head support 12 is removably attached to the anchor 14. As seen in FIG. 1, the head support 12 and anchor 14 are shown in an assembled state and, in FIG. 2, the head support and one embodiment of the anchor 14 are shown in a disassembled state. In alternative embodiment, the anchor 14 is fixed with the head support 12, as further discussed below, and not removeable therefrom.

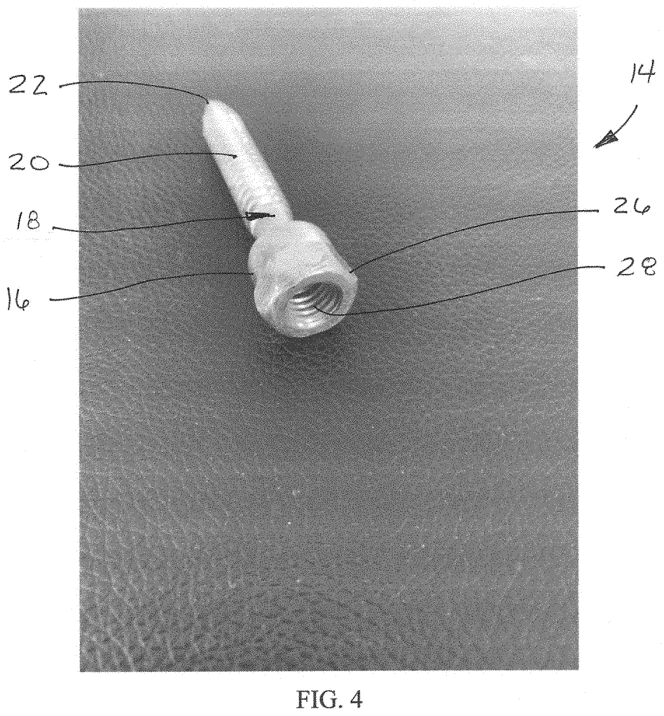

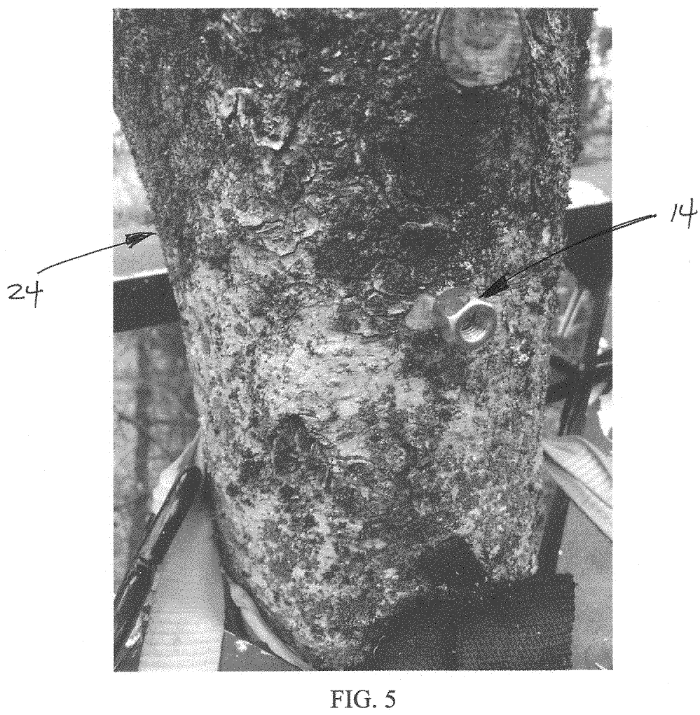

As seen in FIG. 4, the removeable anchor 14 includes a head 16 and a shank 18 extending away from the head 16. The shank 18 is provided with external screw threads 20 terminating in a point 22. The head 16 is located opposite of the point 22 and is shaped to allow, in combination with the screw threads 20, for driving of the anchor 14 into the trunk of a tree 24 (see FIG. 5) or other rigid structure, such as the wood or plastic framing of a hunting blind's enclosure. As such, the external perimeter 26 of the head may be in the form of hex head, or other shape, allowing the anchor 14 to be rotated by a correspondingly shaped driver, such as a wrench or socket. Alternatively, the head 16 may include a socket or recess in the end of the head 16, opposite of the point 22, that received and accepts a corresponding driver, like a hex key (Allen wrench), Torx key (screwdriver or wrench or other style of driver). The combination of the head 16, screw threads 20 and point 22 preferably provide the anchor 14 with self-tapping capabilities, meaning that anchor 14 can be screwed into the support, such as a tree 24, without requiring a pilot hole to be predrilled into the support.

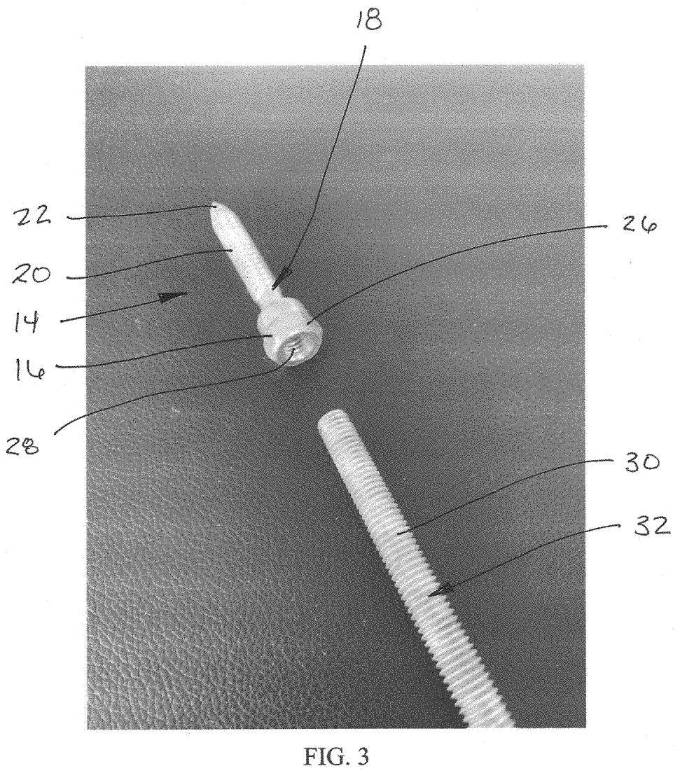

As noted above, the head 16 of the anchor 14 is provided in a manner that enables removeable attachment of the head support 12 to the anchor 14. In a preferred construction, also seen in FIG. 4, the head 16 of the anchor 14 is provided with an internally threaded bore 28. The internal threads of the bore 28 receive corresponding external threads 30 of a mounting shaft 32 that extends from the rear of a cradle 34 of the head support 12. The internal threads 28 of the anchor's head 16 and the external threads 30 of the mounting shaft 32 are seen in FIGS. 2 and 3. The separate anchor 14 and mounting shaft 32 allows the head support 12 to be removeable from the anchor 14, which may remain attached to the support at the location of a hunting stand. In this way, the head support 12 may be used at a different hunting stand locations and used with another anchor 14 that has been mounted at the other hunting stand location. Preferably, the anchor 14 and mounting shaft 32 are formed from galvanized metal or another rust resistant material. The mounting shaft 32 may alternatively be formed from other materials, including plastic, such as fibre-reinforced plastic.

The mounting shaft 32 is provided in a length that allows for the mounting shaft 32 to be shortened, if necessary. As such, the mounting shaft 32 may extend five inches or more from the rear surface of the cradle 34. To shorten the mounting shaft 32, the mounting shaft 32 may be cut with a hacksaw or other suitable cutting tool, depending on the material of the mounting shaft.

As noted above, the mounting shaft 32 extends from the rear of the cradle 34, and more specifically, from a central section 36 along the rear of the cradle 32. The cradle 34 extends laterally or transversely, in opposite directions, from and relative to the axis defined by the mounting shaft 32. The cradle 32 preferably defines a generally arcuate shape, which may be segmentally defined by straight sections (as shown) or defined by a continuously curved member (not shown). As such the cradle 34 has a generally convex side, toward the anchor 14, and a generally concave side, facing opposite or away from the anchor 14. The cradle 32 may be made from a variety of materials, including wood, metal, plastic, etc. The cradle 32 may also be covered or cushioned with a resilient, compressible material, if desired.

As seen in the figures, the cradle 32 is provided generally in the form three straight, segments, the central section 36 and lateral sections 38. The inboard ends of the two lateral sections 38 are angularly cut and secured to square ends of the central section 36 by suitable fasteners, such as wood screws, dowels inserted and glued in bores, etc. Alternatively, the ends of the central section 36 could be angularly provided for securement to squared ends of the lateral sections 38. In a further embodiment, lateral sections 38 and the central section 36 may telescopingly and releasably engage one another. In still a further embodiment, the cradle 34 may be provided as a unitary, one-piece part formed as a molded or bent component.

Also as seen in the figures, the mounting shaft 32 is provided in the form of a carriage bolt extended through the central section 36 of the cradle 34, from the concave side to the convex side, and securely retained by a lock washer and nut 40. Alternatively, the mounting shaft 32 may be insert molded with the cradle 34 to form an integral head support 12 or formed as a unitary component with the cradle 34, such as by injection molding of the entire head support unit.

As an alternative to the illustrated and above described anchor, the anchor 14 may be provided as an attachment to the support that is cinched or otherwise strapped to the support and not threadably inserted or driven into the support.

As a further alternative to the indivual anchor 14 and mounting shaft 32 described above, the anchor 14 and mounting shaft 32 may be integrally or unitarily formed as a screw extending from the cradle 34. In this embodiment, the point 22 and external threads 20 discussed above as being on the anchor 14 are formed with the mounting shaft 32. As such, threads 20 and threads 30 form a continuous thread and the point 22 defines the end of the shaft 32.

The above description is meant to be illustrative of at least one preferred implementation incorporating the principles of the invention. One skilled in the art will really appreciate that the invention is susceptible to modification, variation and change without departing from the true spirit and fair scope of the invention. The terminology used herein is therefore intended to be understood in the nature of words of description and not words of limitation.

I claim:

1. A head rest for mounting to a support member, such as a tree, the head rest comprising:
an anchor attachable to the support member; and
a head support secured to the anchor, the head support including lateral portions extending laterally from a central portion.

2. The head rest according to claim 1, wherein the head support is removably mounted to the anchor.

3. The head rest according to claim 1, wherein the anchor is externally threaded for engagement with the support member.

4. The head rest according to claim 1, wherein the end of the anchor is provided in the form of a point.

5. The head rest according to claim 1, wherein the head support is threadably engaged with the anchor.

6. The head rest according to claim 1, wherein the head support includes a cradle and a mounting member connected at one end to the cradle, an opposing end of the mounting member terminating at the anchor, the cradle generally extending laterally relative to the mounting member.

7. The head rest according to claim 6, where the cradle is generally arcuate along its length.

8. The head rest according to claim 6, wherein cradle includes lateral end portions connected by a central portion.

9. The head rest according to claim 8, wherein the mounting member extends from the central portion.

10. The head rest according to claim 8, wherein the mounting member extends from a generally convex side of the cradle.

11. The head rest according to claim 6, wherein the cradle has a generally convex side facing toward the anchor.

12. The head rest according to claim 11, wherein the cradle has a generally concave side facing away from the anchor.

13. The head rest according to claim 1, wherein the anchor is provided with external threads at a first end and is provided with internal threads at a second end that is opposite from the first end.

14. The head rest according to claim 1, wherein the head support is removably engaged with the anchor via the internal threads.
